(19) United States
(12) Patent Application Publication
(10) Pub. No.: US 2021/0142318 A1
(43) Pub. Date: May 13, 2021

(54) MAPPING SYSTEM AND CORRESPONDING METHOD TO REALIZE DIGITAL ASSETS ON THE MAPPING CHAIN BASED ON DISTRIBUTED TECHNOLOGY

(71) Applicant: SHANGHAI FENFU INFORMATION TECHNOLOGY CO., LTD., Shanghai (CN)

(72) Inventors: Dejun Qian, Shanghai (CN); Zhaojun He, Shanghai (CN); Guochang Xu, Shanghai (CN); Bin Jiang, Shanghai (CN); Xi Luo, Shanghai (CN)

(73) Assignee: SHANGHAI FENFU INFORMATION TECHNOLOGY CO., LTD., Shanghai (CN)

(21) Appl. No.: 17/047,818

(22) PCT Filed: Jul. 19, 2018
(86) PCT No.: PCT/CN2018/096215

§ 371 Date: Oct. 15, 2020

(30) Foreign Application Priority Data
Apr. 16, 2018 (CN) 201810339305.3

(51) Int. Cl. G06Q 20/36; G06Q 20/38; H04L 9/08; G06Q 20/06

(52) U.S. Cl. CPC G06Q 20/3674; G06Q 20/0658; H04L 9/0861; G06Q 20/3829

(57) ABSTRACT

A mapping system and corresponding method to realize digital assets on mapping chain based on distribute technology is provided, the system includes a mapping chain and at least two public chains, the mapping chain generates a private key sharding based on distribute technology and completes the decentralized custody of each private key sharing, and by locking in and locking out the digital assets in at least two public chains, to complete cross-chain communication between at least the two public chains. Using the mapping system and corresponding method to realize digital assets on mapping chain based on distribute technology, the mapping methods that supports different digital assets enables different currencies to be mapped to a mapping chain in a more innovative way thus these tokens can realize multi-currency smart contact on the same chain and become the infrastructure of crypto finance.

### CROSS-REFERENCE TO RELATED APPLICATION

This application claims priority of Chinese Invention Patent Application No. 201810339305.3 filed Apr. 16, 2018, which is incorporated herein by reference.

### FIELD OF TECHNOLOGY

The present invention relates to the field of distributed technology, in particular to the field of blockchain technology, specifically, it refers to a mapping system and corresponding method to realize digital assets on the mapping chain based on distributed technology.

### DESCRIPTION OF RELATED ARTS

Blockchain is essentially a decentralized database, it's like a shared ledger, records the transaction information of all encrypted digital assets, as the underlying technology of Bitcoin, blockchain has the characteristics of decentralization, openness, anonymity and non-tamperability.

The control right of encrypted digital assets is embodied in the control right of private key. Take Bitcoin as an example, the essence of private key is a random number, the private key algorithm of Bitcoin generates 256-bit random number by running SHA256 hash algorithm for random number. Add the version number in front, add compression mark and additional check code in the back (after two SHA-256 operations, take the first four bytes of the hash result twice), and then encode it with Base58, can get the private key in WIF (Wallet import Format) format. Public key is generates through secp256k1 elliptic curve algorithm, Bitcoin address is generates by the public key through hash function (RPIEMD+SHA).

At present, regardless of whether the encrypted digital assets in the hands of individuals or exchange, its private key are completely stored in a decentralized single point. This single point may be the user himself, or it may be a third party that provides a wallet or a decentralized exchange, etc. Therefore, various security issues such as the leakage, theft of private keys and malicious intrusion by third party frequently occur in the field of encrypted digital assets, particularly the encrypted digital asset exchanges have repeatedly occurred serious digital asset thefts event, causing huge losses in users' digital assets.

At the same time, mainstream blockchain networks such as Bitcoin and Ethereum are like islands and cannot communicate directly with each other, different blockchain encrypted digital assets held by users cannot be directly exchanged, that's greatly restricts the application of blockchain.

### SUMMARY OF THE INVENTION

The object of the present invention is to overcome the drawbacks of the above prior arts, provides a mapping system and corresponding method to realize digital assets on mapping chain that can be mapped across chains based on distribute technology.

In order to achieve the above objects, the present invention of mapping system and corresponding method to realize digital assets on mapping chain based on distribute technology has the following composition:

The mapping system to realize digital assets on mapping chain bases on distribute technology, characterized in that, the said system comprises a mapping chain and at least two public chains, the mapping chain generates a private key sharing based on distribute technology and completes the decentralized custodial of each private key sharding, and by locking in and locking out the digital assets in at least the two public chains, to completes cross-chain communication between at least the two public chains.

The method to realize locking in and controlling of digital assets based on the above system, characterized in that, the said method comprises:

(A1) sending a request for locking in the digital asset in a public chain, and triggering a smart contract on the mapping chain for locking in the digital assets;

(A2) the mapping chain generates a private key sharding based on distributed technology, and completes the decentralized custodial of each private key sharding;

(A3) the public chain transfers control right of the digital assets to the mapping chain, in order to realize the distributed management of the digital asset;

(A4) confirming the successfully transferring of control right of the digital assets, and then the smart contract updates the account status of the mapping chain, in order to complete locking in and mapping of the digital assets.

In step (A2) of the method to realize locking in and controlling of digital assets, the mapping chain generates the private key sharding based on the distributed key generation protocol DKG, and to decentralized custodial of each private key sharding.

The method to realize locking in and controlling of digital assets, the decentralized custodial of each private key sharding is specifically:

saving each private key sharding in each node of the mapping chain.

In step (A3) of the method to realize locking in and controlling of digital assets comprises:

(A31) the mapping chain generates a locked address of the public chain based on each private key sharding;

(A32) transferring the digital assets to the locked address, and initiate a transaction broadcast to the mapping chain of transferring the digital assets;

(A33) through the query interface, each node of the mapping chain confirms that the transaction of the digital assets is confirmed on the public chain, and then transfers the control right of the digital assets for which transaction has been completed.

The method to realize locking out and controlling of digital assets based on the above system, characterized in that, the said method comprises:

(B1) initiating a request for locking out in the digital assets in a public chain, in order to trigger a smart contract on the mapping chain for locking out the digital assets;

(B2) each node in the mapping chain respectively receives transaction broadcast information generated based on the triggered smart contract, and completes the transaction of the digital assets when the transaction signature of each the said node reaches threshold value of transaction signature;

(B3) the mapping chain releases the control right of digital assets for which transaction has been completed.

(B4) confirming the successfully release of the control right of the digital assets for which transaction has been completed, and then the smart contract updates the account status of the mapping chain, in order to complete locking out the digital assets and release of the mapping.

Before step (B2) of the method to realize locking out and controlling of digital assets further comprises:

(B20) the triggered smart contract checks the total amount of the digital assets of the public chain, and when the total amount of the digital assets reaches the digital assets to be locked out, the digital assets to be locked out in the public chain are locked in, and the transaction broadcast information is generated based on the triggered smart contract.

The method of transaction broadcast information to realize locking out and controlling of digital assets comprises transaction target address and transaction signature.

In step (B3) of the method to realize locking out and controlling of digital assets is specifically:

through the query interface, each node of the mapping chain confirms that the transaction of the digital assets is confirmed on the public chain, and then releases the control right of the digital assets for which transaction has been completed.

Using the mapping system and corresponding method to realize digital assets on mapping chain based on distribute technology in the present invention, the mapping methods that supports different digital assets enables different currencies to be mapped to a mapping chain in a more innovative way, and no need to make any changes to any public chain, thus these tokens can realize multi-currency smart contact on the same chain, greatly improve the interoperability of the Internet of Value, and become the infrastructure of crypto finance. At the same time, the process of mapping is to securely control the private keys of tokens on various blockchains in a distributed manner, so as to establish a distributed blockchain that manages the control right of tokens. It is like the “highway” on the Internet of Value, which can easily realize value transfer between various tokens and multi-currency smart contracts for crypto finance services.

### BRIEF DESCRIPTION OF THE DRAWINGS

FIG. 1 is a schematic diagram of the main flow of the method to realize locking in digital assets on the mapping chain based on distributed technology of the present invention.

FIG. 2 is a schematic diagram of the decentralized custodial of each private key sharding of the present invention.

### DETAILED DESCRIPTION OF THE PREFERRED EMBODIMENT

In order to be able to understand the technical content of the present invention more clearly, is further exemplified by the following detailed description of embodiments.

The mapping system to realize digital assets on the mapping chain based on distributed technology, wherein, the said system comprises a mapping chain and at least two public chains, the mapping chain generates a private key sharding based on distributed technology and completes the decentralized custodial of each private key sharding, and by locking in and locking out the digital assets in at least the two public chains, to completes cross-chain communication between at least the two public chains, it is worth noting that the nature of the mapping chain in the present invention is public chain, which is used to map assets of other mainstream public chains, so it is called “mapping chain”.

The method to realize locking in and controlling of digital assets based on the above system (refer to FIG. 1), characterized in that, the said method comprises:

(A1) sending a request for locking in the digital assets in a public chain, and triggering a smart contract on the mapping chain for locking in the digital assets;

(A2) the mapping chain generates a private key sharding based on distributed technology, and completes the decentralized custodial of each private key sharding;

(A3) the public chain transfers control right of the digital assets to the mapping chain, in order to realize the distributed management of the digital assets;

(A4) confirming the successfully transferring of control right of the digital assets, and then the smart contract updates the account status of the mapping chain, in order to complete locking in and mapping of the digital assets.

In step (A2) of the method to realize locking in and controlling of digital assets, the mapping chain generates the private key sharding based on the distributed key generation protocol DKG (Distributed Key Generation), and to decentralized custodial of each private key sharding.

The method to realize locking in and controlling of digital assets which that decentralized custodial of private key sharding is specifically (refer to FIG. 2):

saving each private key sharding in each node of the mapping chain.

In step (A3) of the method to realize locking in and controlling of digital assets comprises: (A31) the mapping chain generates a locked address of the public chain based on each private key sharding;

(A32) transferring the digital assets to the locked address, and initiate a transaction broadcast to the mapping chain of transferring the digital assets;

(A33) through the query interface, each node of the mapping chain confirms that the transaction of the digital assets is confirmed on the public chain, and then transfers the control right of the digital assets for which transaction has been completed.

The method to realize locking out and controlling of digital assets based on the above system, characterized in that, the said method comprises:

(B1) initiating a request for locking out in the digital assets in a public chain, in order to trigger a smart contract on the mapping chain for locking out the digital assets; (B2) each node in the mapping chain respectively receives transaction broadcast information generated based on the triggered smart contract, and completes the transaction of the digital assets when the transaction signature of each the said node reaches threshold value of transaction signature;

(B3) the mapping chain releases the control right of digital assets for which transaction has been completed.

(B4) confirming the successfully release of the control right of the digital assets for which transaction has been completed, and then the smart contract updates the account status of the mapping chain, in order to complete locking out the digital assets and release of the mapping.

Before step (B2) of the method to realize locking out and controlling of digital assets further comprises:

(B20) the triggered smart contract checks the total amount of the digital assets of the public chain, and when the total amount of the digital assets reaches the digital assets to be locked out, the digital assets to be locked out in the public chain are locked in, and the transaction broadcast information is generated based on the triggered smart contract.

The method of transaction broadcast information to realize locking out and controlling of digital assets comprises transaction target address and transaction signature.

In step (B3) of the method to realize locking out and controlling of digital assets is specifically:

through the query interface, each node of the mapping chain confirms that the transaction of the digital assets is confirmed on the public chain, and then releases the control right of the digital assets for which transaction has been completed.

Preferably, the public chain in the process of locking in and locking out of the prevent invention just meets the requirement that its address is the controlled by private key, all can use the mapping system to realize digital assets on the mapping chain based on distributed technology of the prevent invention to do further operation, preferably, digital asset mapping can be performed.

In a specific embodiment, in the mapping system to realize digital assets on the public block chain based on distributed technology of the prevent invention, two steps of locking in (lock in) and locking out (lock out) will be carried out, when performing lock in, how to ensure that the private key is effectively generated, custody and used is not leaked, which is a key issue for safely and reliably to realize performing lock in of digital assets. If the private key is completely stored in one place, it will be leaked due to node attract or malicious node collection. Therefore in order to ensure the security of the private key, choose to shrading the private key and hand it over to different node to custody (FIG. 2).

The key point of the technical solution proposed by the prevent invention are as follows:

(1) Distributed Generation of Private Key

Distributed generation of private key, it is done in by distribute development of multiple nodes in the mapping chain, each node just generates and save a part of the private key, and there is no transmission and assembly of private key sharding between each other. In this process, the number of sharding is determined according to the algorithm of key sharding, and a virtual node group is formed according to this number to generate the private key. In order to ensure that the key of decentralized custodial are always available, the algorithm for generating the number of nodes in the node group will ensure that the probability that enough nodes are not online at the same time is within a very small range. The shards are independently and randomly generate by the nodes in the group according to the determined shards length and finally form the value of shards according to the established consensus mechanism.

(2) Transaction Signature During Locking Out

When a transaction that requires signature verification is broadcast, the node can verify it according to its own saved private key sharding. After the verification is successful, the node signatures the verification result and broadcasts it. In this process, the transmission content is irreversible, therefore, the key or private key sharding cannot be deduced from any content broadcast.

(3) Signature Confirmation

When the node completes the private key sharding verification, it collects the results of each node's signature through broadcasting, when the number of signatures of a transaction reaches the threshold, the transaction is considered effective.

In a specific embodiment, take Bitcoin (equivalent to the public chain in the present invention) and Fusion chain (equivalent to the mapping chain in the present invention, and its nature is also a public chain) as examples to introduce the process of mapping Bitcoin to the Fusion chain:

when user A initiates a lock in of 10 Bitcoins (BCT). The user will use the wallet as an interactive interface. This wallet has many functions of current multi-currency wallet, but at same time it also has the function of lock in and managing different digital assets. In addition, the wallet will also have various financial services developed by third party on the public chain, that users can conveniently participate after completing the lock in.

Among them, the realization process of locking in (lock in) as follows:

the user's experience of initiating a lock in request to the wallet is similar in operation to the experience of existing wallet transfers. The specific implementation steps are follows:

(1) Initiate a Lock in Request

User A initiate lock in request for 10 BTC to the Fusion chain by calling the program interface of locking in in the wallet.

(2) Distributed Private Key Generation

The request operation triggers the smart contract of locking in (lock in) on the Fusion chain, and the smart contract organizes the initialization of the private key. So-called initialization of the private key is to generate the private key sharding in a distributed manner and complete the decentralized custodial of the each private key sharding.

(3) Transfer the Control Right to Distributed Management

The initialization is completed and generate a lock in address, the lock in address is an address on the Bitcoin chain, and user A initiates a transfer to the address. The user initiates the transfer operation and broadcasts this lock in on Fusion chain through interface, and the node on Fusion chain to checks the completion of the transfer.

When the node on the Fusion chain receives the transaction broadcast, it querying whether the transaction is confirmed on the Bitcoin chain through third party interface. By consensus result shows that these 10 BTC are successfully transferred to the address of generated by lock in, which is regarded as a successful transfer of distributed control right management.

(4) Digital Assent Mapping

Confirm the successful transfer of the control right, and then the smart contract completes the status update of user A's account on the Fusion chain. The lock in record is packaged and recorded by the node into a block on the Fusion chain. So far, user A's 10 BTC lock in request is completed.

Similarly, the user's request of lock out is also initiate by calling the relevant program interface in the wallet. The user experience is similar to use wallet for external transfers. The implementation process of locking out is as follows:

(1) Initiate a Lock Out Request

User A operates in the wallet to initiate a transfer transaction of 10 BTC to an out-of-chain Bitcoin address, which is regarded as the user initiates a lock out request.

(2) Check, Lock in and Generate Transactions

The transaction triggers a lock out smart contract on the Fusion chain, the contract will first check the user A's asset status on the Fusion chain, when the transfer condition are met, lock in the status of 10 Bitcoins of user A in the Fusion chain account, and generate a transfer transaction with the target address and user's signature.

(3) Threshold Signature

The node on the Fusion chain receives the transaction instruction, to begin calculation and comparison based on the private key sharding of their respective stored, and the successful nodes will signature the result and broadcast it. Each node collects the signatures at same time, when the transaction signature reaches the requirement of t/m, (t≤m) threshold, generally t/m is ⅔, the transaction is sent to the Bitcoin main chain by the node, and realize the transaction of transferring 10 BTC to the address specified by user A.

(4) Release Distributed Control Right Management

The nodes on the Fusion chain will check whether the transaction is confirmed on the Bitcoin main chain through the Bitcoin corresponding interface. When the consensus has reached the result of the transaction confirmation, the user A's 10 BTC will released from the distributed control right management.

(5) Release and Destroy Digital Assets

The smart contract synchronously updates the status of user's account on Fusion, and completes the release and destroy of the mapping by deducting the 10 locked in BTC mapping. At the same time, the lock out record is packaged and recorded into a block on the Fusion.

So far, the user's lock out request is completed.

Finally, when distributed control right transfer is completed, and then the state update of main chain account balance can reflect the completion of locking in (lock in) or locking out (lock out). The process of the accounting, the main chain actually issues or recovers the tokens used for accounting of the same amount of digital assets to the user account, thus completing the mapping of digital assets to the main chain or release mapping from it.

Using the mapping system and corresponding method to realize different digital assets on public blockchain based on distribute technology in the present invention, the mapping methods that supports different digital assets enables different currencies to be mapped to a mapping chain in a more innovative way, and no need to make any changes to any public chain, thus these tokens can realize multi-currency smart contact on the same chain, greatly improve the interoperability of the Internet of Value, and become the infrastructure of crypto finance. At the same time, the process of mapping is to securely control the private keys of tokens on various blockchains in a distributed manner, so as to establish a distributed blockchain that manages the control right of tokens. It is like the “highway” on the Internet of Value, which can easily realize value transfer between various tokens and multi-currency smart contracts for crypto finance services.

In this specification, the present invention has been described with the reference to its specific embodiments. However, it is obvious still may be made without departing from the spirit and scope of the present invention, various modifications and transformation. Accordingly, the specification and drawings should be considered as illustrative rather than restrictive.

I claim:

1. A mapping system to realize digital assets on the mapping chain based on distributed technology, characterized in that, the said system comprises a mapping chain and at least two public chains, the mapping chain generates a private key sharding based on distributed technology and completes the decentralized custodial of each private key sharding, and by locking in and locking out the digital assets in at least the two public chains, to completes cross-chain communication between at least the two public chains.

2. A method to realize locking in and controlling of digital assets based on the said system of claim 1, characterized in that, the method comprises:
(A1) sending a request for locking in the digital assets in a public chain, and triggering a smart contract on the mapping chain for locking in the digital assets;
(A2) the mapping chain generates a private key sharding based on distributed technology, and completes the decentralized custodial of each private key sharding;
(A3) the public chain transfers control right of the digital assets to the mapping chain, in order to realize the distributed management of the digital assets;
(A4) confirming the successfully transferring of control right of the digital assets, and then the smart contract updates the account status of the mapping chain, in order to complete locking in and mapping of the digital assets.

3. The method to realize locking in and controlling of digital assets according to claim 2, characterized in that, in the step (A2), the mapping chain generates the private key sharding based on the distributed key generation protocol DKG, and to decentralized custodial of each private key sharding.

4. The method to realize locking in and controlling of digital assets according to claim 3, characterized in that, the decentralized custodial of each private key sharding is specifically:
saving each private key sharding in each node of the mapping chain.

5. The method to realize locking in and controlling of digital assets according to claim 4, characterized in that, the step (A3) comprises:
(A31) the mapping chain generates a locked address of the public chain based on each private key sharding;
(A32) transferring the digital assets to the locked address, and initiate a transaction broadcast to the mapping chain of transferring the digital assets;
(A33) through the query interface, each node of the mapping chain confirms that the transaction of the digital assets is confirmed on the public chain, and then transfers the control right of the digital assets for which transaction has been completed.

6. A method to realize locking out and controlling of digital assets based on the said system of claim 1, characterized in that, the method comprises:
(B1) initiating a request for locking out in the digital assets in a public chain, in order to trigger a smart contract on the mapping chain for locking out the digital assets;
(B2) each node in the mapping chain respectively receives transaction broadcast information generated based on the triggered smart contract, and completes the transaction of the digital assets when the transaction signature of each the said node reaches threshold value of transaction signature;
(B3) the mapping chain releases the control right of digital assets for which transaction has been completed.
(B4) confirming the successfully release of the control right of the digital assets for which transaction has been completed, and then the smart contract updates the account status of the mapping chain, in order to complete locking out the digital assets and release of the mapping.

7. The method to realize locking out and controlling of digital assets according to claim 6, characterized in that, prior to step (B2) further comprises:
(B20) the triggered smart contract checks the total amount of the digital assets of the public chain, and when the total amount of the digital assets reaches the digital assets to be locked out, the digital assets to be locked out in the public chain are locked in, and the transaction broadcast information is generated based on the triggered smart contract.

8. The method to realize locking out and controlling of digital assets according to claim 7, characterized in that, the transaction broadcast information comprises transaction target address and transaction signature.

9. The method to realize locking out and controlling of digital assets according to claim 6, characterized in that, the step (B3) is specifically:
through the query interface, each node of the mapping chain confirms that the transaction of the digital assets is confirmed on the public chain, and then releases the control right of the digital assets for which transaction has been completed.
